(19) United States
(12) Patent Application Publication
(10) Pub. No.: US 2026/0188111 A1
(43) Pub. Date: Jul. 2, 2026

(54) DETERMINATION DEVICE, TERMINAL, SERVER, DETERMINATION METHOD, AND COMPUTER-READABLE STORAGE MEDIUM

(71) Applicant: HONDA MOTOR CO.,LTD., Tokyo (JP)

(72) Inventor: Takahiro KUREHASHI, Saitama (JP)

(21) Appl. No.: 19/350,064

(22) Filed: Oct. 6, 2025

(30) Foreign Application Priority Data
Dec. 26, 2024 (JP) 2024-229863

(51) Int. Cl. G08G 1/09; G01S 19/24; G01S 19/45; H04W 4/33

(52) U.S. Cl. CPC G08G 1/093; G01S 19/24; G01S 19/45; H04W 4/33

(57) ABSTRACT

A determination device includes an index value acquisition unit which acquires an index value of a positioning precision based on a satellite signal detected by a terminal, a movement information acquisition unit which acquires movement information of the terminal, a storage unit which stores map information, a determination unit which determines whether or not the terminal is indoors based on comparison between the index value and a threshold, and a setting unit which sets the threshold based on the movement information and the map information. A determination method includes acquiring an index value of a positioning precision based on a satellite signal detected by a terminal; acquiring movement information of the terminal; storing map information; setting a threshold based on the movement information and the map information; and determining whether or not the terminal is indoors based on a comparison between the index value and the threshold.

The contents of the following patent application(s) are incorporated herein by reference:

NO. 2024-229863 filed in JP on December 26, 2024.

### BACKGROUND

### 1. TECHNICAL FIELD

The present invention relates to a determination device, a terminal, a server, a determination method, and a computer-readable storage medium.

### 2. RELATED ART

Patent Literatures 1-2 describe that, when a GPS signal lower than a predetermined value is sensed, it is determined that the mobile phone has entered a building.

### Citation List

### Patent Literature

Patent Literature 1: Japanese Patent Application Publication No. 2005-291933

Patent Literature 2: Japanese Patent Application Publication No. 2009-109500

### BRIEF DESCRIPTION OF THE DRAWINGS

FIG. 1 schematically illustrates a usage scene of an assistance system 10.

FIG. 2 illustrates a functional configuration of a terminal 82.

FIG. 3 illustrates a functional configuration of a server 60.

FIG. 4 schematically illustrates the temporal change of the satellite signal detected by the terminal 82 entering a building 92.

FIG. 5 schematically illustrates the temporal change of the satellite signal in the terminal 82 leaving the building 92.

FIG. 6 illustrates a flowchart related to a determination method executed in the terminal 82 and a server 60.

FIG. 7 illustrates an example of an execution sequence of processes performed at the terminal 82, an in-vehicle information processing device 40 of a vehicle 20, and the server 60.

FIG. 8 illustrates another example of an execution sequence of processes performed at the terminal 82, the in-vehicle information processing device 40 of the vehicle 20, and the server 60.

FIG. 9 illustrates another example of an execution sequence of processes performed at the terminal 82, the in-vehicle information processing device 40 of the vehicle 20, and the server 60.

FIG. 10 illustrates an example of a computer 2000 in which a plurality of embodiments of the present invention may be entirely or partially embodied.

### DESCRIPTION OF EXEMPLARY EMBODIMENTS

The present invention will be described below through embodiments of the invention, but the following embodiments do not limit the invention according to the claims. In addition, not all combinations of features described in the embodiments are essential to a solution of the invention.

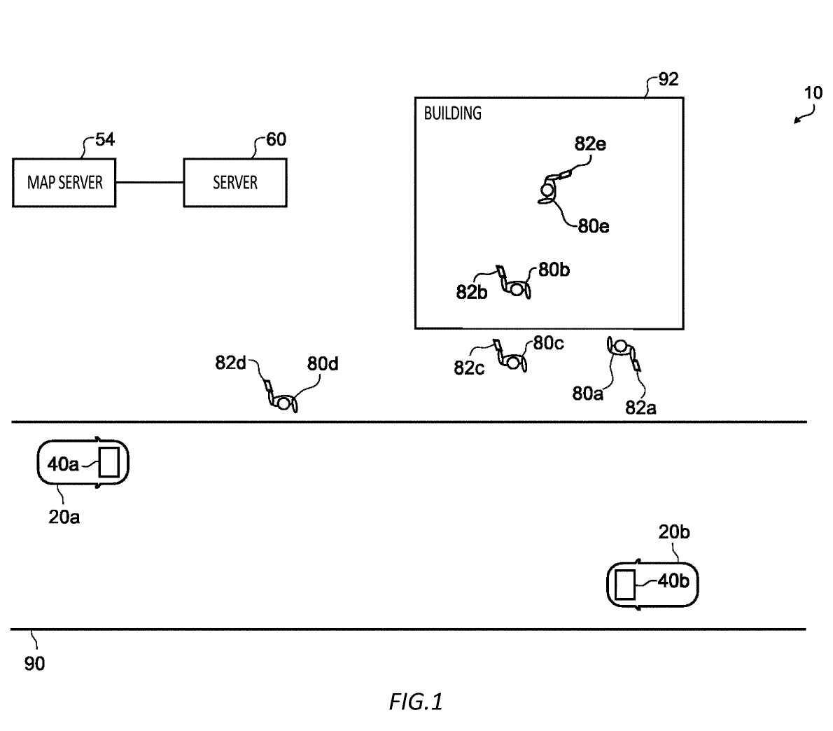

FIG. 1 schematically illustrates a usage scene of an assistance system 10. The assistance system 10 includes a vehicle 20a, a vehicle 20b, a terminal 82a, a terminal 82b, a terminal 82c, and a terminal 82d, a server 60, and a map server 54.

The vehicle 20a includes an in-vehicle information processing device 40a, and the vehicle 20b includes an in-vehicle information processing device 40b. The terminal 82a is a terminal possessed by a person 80a, the terminal 82b is a terminal possessed by a person 80b, the terminal 82c is a terminal possessed by a person 80c, the terminal 82d is a terminal possessed by a person 80d, and the terminal 82e is a terminal possessed by a person 80e.

In the present embodiment, the vehicle 20a and the vehicle 20b are sometimes collectively referred to as “vehicle 20”. The in-vehicle information processing device 40a and the in-vehicle information processing device 40b are sometimes collectively referred to as “in-vehicle information processing device 40”. The terminal 82a, the terminal 82b, the terminal 82c, the terminal 82d, and the terminal 82e are sometimes collectively referred to as “terminal 82”. The person 80a, the person 80b, the person 80c, the person 80d, and the person 80e are sometimes collectively referred to as “person 80”. The person 80 is, for example, a pedestrian.

The vehicle 20 is a vehicle which travels on a road 90. The vehicle 20 is an example of a moving object. The vehicle 20 is configured to include various sensors such as a location sensor including a receiver for receiving a satellite signal from a Global Navigation Satellite System (GNSS) satellite, a vehicle speed sensor, a capturing device, and a radar. The in-vehicle information processing device 40 has a function to process information acquired by the various sensors included in the vehicle 20. The in-vehicle information processing device 40 includes a function to communicate with each of the in-vehicle information processing device 40 of another vehicle 20, the server 60, and the map server 54. The in-vehicle information processing device 40 provides an Advanced Driver-Assistance Systems (ADAS) function included in the vehicle 20.

The terminal 82 is a mobile terminal such as, for example, a smartphone. The terminal 82 is an example of the mobile terminal. The terminal 82 receives, for example, a satellite signal from a satellite such as a GNSS satellite, and measures the current location of the terminal 82 based on the received satellite signal. The terminal 82 periodically transmits, to the server 60, location information indicating the measured current location of the terminal 82.

The server 60 receives, through mobile communication, the information transmitted by the in-vehicle information processing device 40 and the terminal 82. The server 60 may receive, through mobile communication and communication lines such as the Internet and a dedicated line, the information transmitted from the in-vehicle information processing device 40 and the terminal 82.

The server 60 performs traffic assistance for the vehicle 20 based on the location information of the vehicle 20 and the person 80 received from the in-vehicle information processing device 40 and the user terminal 82. For example, when the server 60 determines whether or not the person 80 and the vehicle 20 will approach each other within a predetermined time based on the location information of the vehicle 20 and the person 80 and determines that the person 80 and the vehicle 20 will approach each other within the predetermined time, it performs the traffic assistance for the vehicle 20 and/or the person 80. For example, the server 60 performs the traffic assistance by transmitting, as the information indicating the traffic risk, warning information indicating the in-vehicle information processing device 40 and the user terminal 82 to output a warning.

In the present embodiment, the terminal 82 determines whether or not the terminal 82 is within a building. When the terminal 82 determines that the terminal 82 is not within the building, it transmits the location information of the terminal 82. On the other hand, when the terminal 82 determines that the terminal 82 is within the building, it suppresses the transmission of the location information by the terminal 82. For example, the terminal 82d outside the building 92 transmits the location information while the terminal 82e within the building 92 transmits no location information.

The terminal 82 acquires map information from the map server 54. The terminal 82 acquires the map information from the map server 54 in advance and/or in real-time. The terminal 82 permanently or semi-permanently or temporarily stores the acquired map information. The map information includes building information, including the location information of the building 92. The terminal 82 calculates the index value indicating the positioning precision of the terminal 82 calculated based on the received satellite signal. Examples of “the index value indicating the positioning precision of the terminal 82” can include, for example, the reception sensitivity of the satellite signal by the terminal 82, the number of satellites whose satellite signals have been received by the terminal 82, the elevation angle of the satellite signal, and the like.

The terminal 82 acquires the movement information of the terminal 82. The terminal 82 acquires the movement information of the terminal 82 based on, for example, the history of the location information. The movement information is, for example, the information indicating the current location of the terminal 82 and the moving direction of the terminal 82. The terminal 82 determines whether or not the terminal 82 is indoors, based on the comparison between the index value and a threshold. For example, when the index value is equal to or less than the threshold, the terminal 82 determines that the terminal 82 is indoors. When the index value exceeds the threshold, the terminal 82 determines that the terminal 82 is not indoors. For example, when the index value exceeds the threshold, the terminal 82 determines that the terminal 82 is outdoors.

In the present embodiment, the terminal 82 sets the threshold based on the movement information and the map information. For example, when it is determined that the terminal 82 is moving in the direction of approaching the building 92 based on the building information and the movement information, the terminal 82 sets the threshold to a value higher than a predetermined value; or when it is determined that the terminal 82 is moving in the direction of moving away from the building 92, the terminal 82 sets the threshold to a value lower than the predetermined value. In this way, for example, the terminal 82a moving in the direction toward the building 92 sets the threshold to a higher value than the terminal 82c, for example, which is moving in the direction of moving away from the building 92. Therefore, the terminal 82a is likely to be determined to be within the building 92. Since the terminal 82a is moving toward the building 92, there is little need to perform traffic assistance for the person 80a who possesses the terminal 82a. According to the present embodiment, the transmission of the location information can be suppressed in the terminal 82a, which has little need for the traffic assistance to be performed. In this way, the power consumption to transmit the location information can be reduced in the terminal 82a. Furthermore, this can reduce the computation amount required for the process performed by the server 60 for the traffic assistance.

The terminal 82c, which is moving in the direction of moving away from the building 92, sets the threshold to a lower value than, for example, the terminal 82a, which is moving in the direction of approaching the building 92. Therefore, the terminal 82c is likely to be determined to be outside the building 92. Since the terminal 82c is moving in the direction of moving away from the building 92, there is a high need to perform the traffic assistance for the person 80c who possesses the terminal 82c. According to the present embodiment, the terminal, such as the terminal 82c, that has a high need for the traffic assistance to be performed can be facilitated to transmit the location information. In this way, the traffic safety can be enhanced.

The terminal 82b is a terminal that is located within the building 92 and near the entrance of the building 92. The moving direction of the terminal 82b is the same direction as the moving direction of the terminal 82c. In other words, the terminal 82b is moving in the direction of moving away from the building 92. Like the terminal 82c, the terminal 82b sets the threshold to a lower value than, for example, the terminal 82a, which is moving in the direction of approaching the building 92. Therefore, the terminal 82b that is within the building 92 and near the entrance is likely to be determined to be outside the building 92. Since the terminal 82b is moving in the direction of leaving the building 92, there is a relatively high need to perform the traffic assistance for the person 80b who possesses the terminal 82b. According to the present embodiment, the terminal, such as the terminal 82b, that has a relatively high need to perform the traffic assistance can be facilitated to quickly start transmitting the location information.

When the terminal 82, such as the terminal 82b and the terminal 82c, is near the entrance of the building 92, the reception sensitivity of the satellite signal received by the terminal 82 is lower than when the terminal 82 is outside the building 92. Therefore, it is sometimes difficult to determine whether the terminal 82 is within the building 92 or outside the building 92 by using the index value such as the reception sensitivity. In addition, for example, there is a time lag between the moment the terminal 82 starts detecting the location information and the moment it starts transmitting the location information. Therefore, it sometimes takes a certain amount of time from the moment the terminal 82 leaves the building 92 to the moment the transmission of the location information of the terminal 82b starts. In contrast, according to the present embodiment, it is possible to reduce the likelihood that the state in which the location information is not transmitted even though the terminal 82 has left the building 92 continues. In this way, the traffic safety can be enhanced.

In the present embodiment, like the terminal 82, the server 60 has a function to determine whether or not the terminal 82 is indoors. For example, the server 60 receives, from the terminal 82, the location information of the terminal 82 and the information indicating the index value indicating the positioning precision of the terminal 82. The server 60 sets the threshold based on the map information and the movement information and determines whether or not the terminal 82 is indoors based on the comparison between the location of the terminal 82, indicated by the location information received by the terminal 82, and the threshold. The server 60 performs traffic assistance by considering the determination result of whether or not the terminal 82 is indoors. The server 60 has a function of determining whether or not the terminal 82 is indoors, so that the server 60 can perform traffic assistance by considering the determination result of whether or not the terminal 82 is indoors, even if there is a terminal 82 that has no function of determining whether or not its own terminal is indoors.

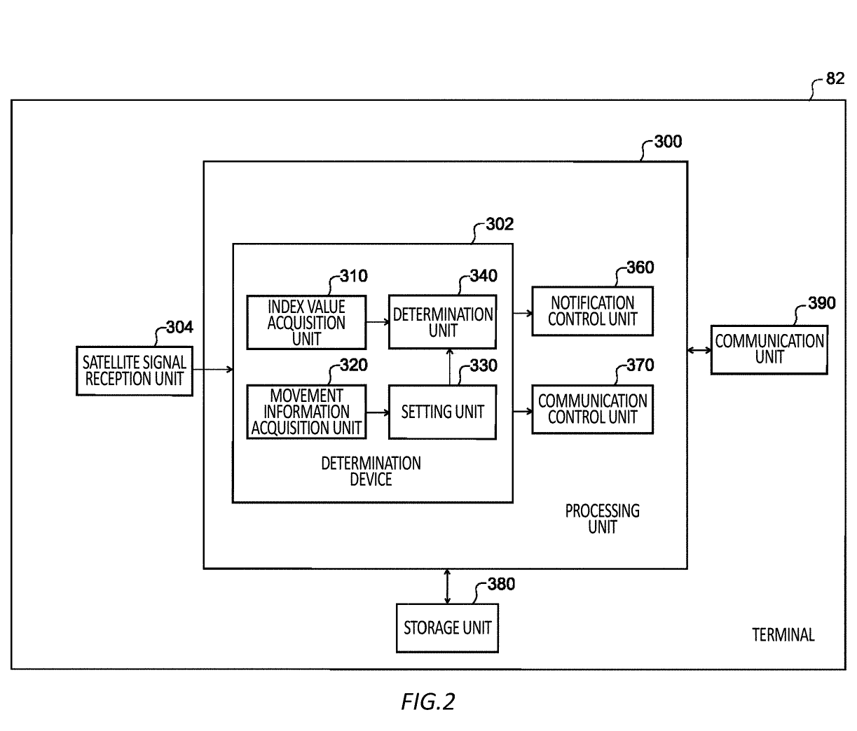

FIG. 2 illustrates the functional configuration of the terminal 82. The terminal 82 includes a processing unit 300, a satellite signal reception unit 304, a communication unit 390, and a storage unit 380.

The communication unit 390 is responsible for communication with the server 60 under the control of the processing unit 300. The processing unit 300 is implemented to include, for example, a circuit such as a computation processing device including a processor. The processing unit 300 may be implemented as a microcomputer including a CPU, a ROM, a RAM, an I/O, a bus, and the like. The storage unit 380 is implemented to include a non-volatile storage medium. The processing unit 300 performs processing by using information stored in the storage unit 380. The storage unit 380 may store the map information acquired from the map server. The map information stored in the storage unit 380 may be used by the processing unit 300.

The processing unit 300 includes a determination device 302, a notification control unit 360, and a communication control unit 370. The determination device 302 includes an index value acquisition unit 310, a determination unit 340, a movement information acquisition unit 320, and a setting unit 330. An embodiment may be adopted where the terminal 82 does not have a part of the functions among the functional configuration illustrated in FIG. 2.

The satellite signal reception unit 304 receives the satellite signal transmitted from the positioning satellite such as a GNSS satellite, and outputs the location of the terminal 82 based on the received signal. The satellite signal reception unit 304 further outputs the index value indicating the positioning precision based on the satellite signal. The index value includes at least one of the reception sensitivity of the satellite signal, the number of satellites used for positioning, or the elevation angle of the satellite signal. The reception sensitivity may be the intensity of the received signal. The reception sensitivity may be, for example, the information indicating the signal intensity of the satellite signal received by the terminal 82. The reception sensitivity may be a signal-to-noise ratio, a carrier-to-noise power density ratio, or the like. The number of satellites used for positioning may be the number of satellites that may be used for positioning or the number of satellites that have been used for positioning. The index value of the elevation angle of the satellite signal may be the average value of the received elevation angles of the satellite signals or may be the average value of the elevation angles of the satellite signals that have elevation angles greater than a predetermined value. The index value may be various DOP values or the like. The satellite signal reception unit 304 may output other various types of index values indicating the positioning precision.

The index value acquisition unit 310 acquires the index value of the positioning precision based on the satellite signal detected by the terminal 82. The index value acquisition unit 310 acquires the index value output by the satellite signal reception unit 304.

The movement information acquisition unit 320 acquires the movement information of the terminal 82. For example, the movement information acquisition unit 320 acquires the movement information of the terminal 82 based on the location of the terminal 82 detected by the satellite signal reception unit 304. The movement information of the terminal 82 may be the information indicating the current location of the terminal 82 and the moving direction of the terminal 82. The movement information of the terminal 82 may be the information indicating the current location of the terminal 82 and the moving direction of the terminal 82. The moving direction may be acquired based on the history of the location of the terminal 82. The moving direction may be acquired based on the information output from various sensors detecting the information related to the moving direction of the terminal 82. Examples of the sensor can include an acceleration sensor, an orientation sensor, and the like.

The storage unit 380 stores the map information. The storage unit 380 may store the map information received from the map server 54. The storage unit 380 may temporarily store the map information received from the map server 54.

The determination unit 340 determines whether or not the terminal 82 is indoors based on the comparison between the index value and the threshold. When the index value is equal to or less than the threshold, the determination unit 340 may determine that the terminal 82 is indoors. When the index value exceeds the threshold, the determination unit 340 may determine that the terminal 82 is not indoors.

The setting unit 330 sets the threshold based on the movement information and the map information. The map information may include the building information indicating the location of the building, and the setting unit 330 may set the threshold to a value higher than a predetermined value when it is determined that the terminal 82 is moving in the direction of approaching the building 92 based on the building information and the movement information. In this way, for example, when it is determined that the moving direction of the terminal 82 matches the direction entering the building 92, the setting unit 330 can increase the threshold so that the terminal 82 is likely to be determined to be within the building 92. In this way, a process needed when the terminal 82 is outdoors can be omitted.

The map information may include the building information indicating the location of the building, and the setting unit 330 may set the threshold to a value lower than a predetermined value when it is determined that the terminal 82 is moving in the direction of moving away from the building 92 based on the building information and the movement information. In this way, for example, when it is determined that the moving direction of the terminal 82 matches the direction of leaving the building 92, the setting unit 330 can lower the threshold so that the terminal 82 is likely to be determined to be outside the building 92. In this way, a process needed when the terminal 82 is outdoors can be quickly started.

The map information includes the building information indicating the location of the building, and the setting unit 330 may set the threshold to a higher value when it is determined that the terminal 82 is moving in the direction of approaching the building 92 based on the building information and the movement information than when it is determined that the terminal 82 is moving in the direction of moving away from the building 92. In this manner, the threshold is set based on the movement information and the map information so that determination of whether or not the terminal 82 is indoors can be appropriately performed when the terminal 82 is near the entrance of the building 92.

The map information may include the obstacle information indicating the presence of an obstacle around the building. The obstacle may be an object or feature that obstructs the travel of the vehicle 20. The obstacle may be an object or feature that obstructs the travel of the vehicle 20 and substantially surrounds a predetermined area. Examples of the obstacles can include a wall and a moat. The obstacle information may be the information indicating the extent of the wall’s presence, or may be the information indicating the extent of the moat’s presence. The obstacle may be an object or feature that obstructs the travel of the vehicle 20. The obstacle information may be the information indicating the extent of the wall’s presence determined based on an aerial photograph or a satellite photograph, or may be the information indicating the extent of the moat’s presence determined based on an aerial photograph or a satellite photograph.

The setting unit 330 may set the threshold based on the obstacle information and the movement information. When it is determined that the terminal 82 is moving in the direction of approaching the obstacle based on the movement information and the obstacle information, the setting unit 330 may set the threshold to a value higher than a predetermined value. When it is determined that the terminal 82 is moving in the direction of moving away from the obstacle based on the obstacle information and the movement information, the setting unit 330 may set the threshold to a value lower than a predetermined value. When it is determined that the terminal 82 is moving in the direction of approaching the obstacle based on the obstacle information and the movement information, the setting unit 330 may set the threshold to a higher value than when it is determined that the terminal 82 is moving in the direction of moving away from the obstacle.

The communication control unit 370 controls the communication content between the terminal 82 and the external server 60 based on the determination result of the determination unit 340. For example, the communication unit 390 transmits the location information of the terminal 82 to the server 60 that distributes the information indicating the traffic risk at the location where the terminal 82 is located, and the communication control unit 370 restricts the transmission of the location information to the server by the communication unit 390 based on the determination result of the determination unit 340.

From the server 60 that distributes the information indicating the traffic risk, the communication unit 390 receives the information indicating the traffic risk at the location where the terminal 82 is located. The notification control unit 360 performs control to perform notification based on the information indicating the traffic risk received by the communication unit 390. The notification control unit 360 restricts the notification when the determination unit 340 determines that the terminal 82 is indoors. In this way, when it is determined that the terminal 82 is indoors, the notification of the information related to the traffic risk can be suppressed.

The communication unit 390 may transmit the index value acquired by the index value acquisition unit 310 to the server 60. In this way, the server 60 can appropriately determine whether or not the terminal 82 is indoors. The communication unit 390 may transmit the determination result of the determination unit 340 to the server that distributes the information indicating the traffic risk at the location where the terminal 82 is located.

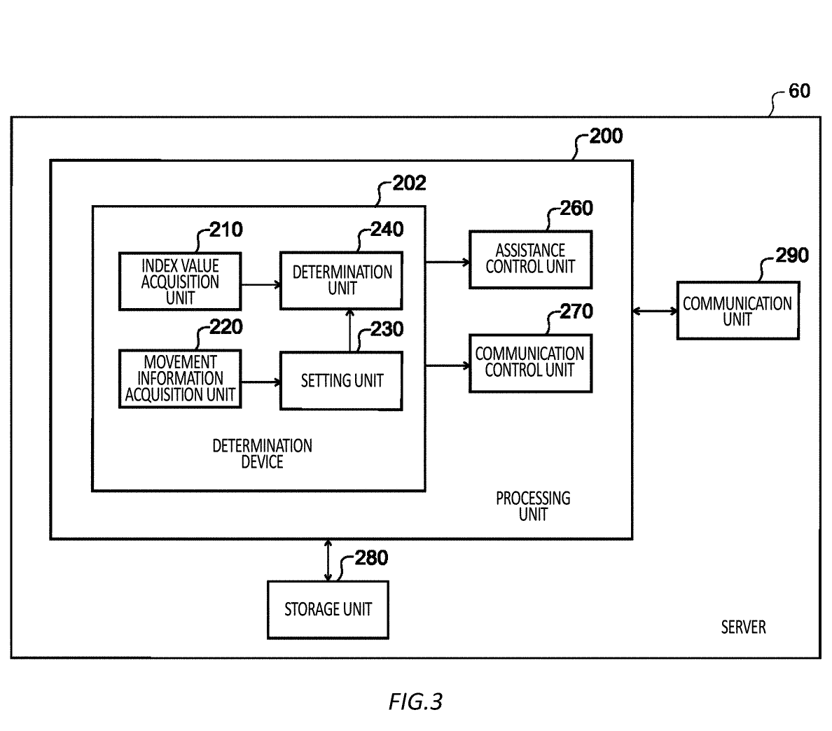

FIG. 3 illustrates a functional configuration of the server 60. The server 60 includes a processing unit 200, a communication unit 290, and a storage unit 280.

The communication unit 290 is responsible for communication between each of the in-vehicle information processing device 40 and the terminal 82 and the server 60 under the control of the processing unit 200. The processing unit 200 is implemented to include, for example, a circuit such as a computation processing device including a processor. The processing unit 200 may be implemented by a microcomputer including a CPU, ROM, RAM, I/O, bus, and the like. The storage unit 280 is implemented to include a non-volatile storage medium. The processing unit 200 performs processing by using information stored in the storage unit 280. The storage unit 280 may store the map information acquired from the map server. The map information stored in the storage unit 280 may be used by the processing unit 200.

The communication unit 290 receives the location information transmitted from the terminal 82. The communication unit 290 receives the index value of the positioning precision, which is based on the satellite signal detected by the terminal 82, transmitted from the terminal 82.

The processing unit 200 includes a determination device 202, an assistance control unit 260, and a communication control unit 270. The determination device 202 includes an index value acquisition unit 210, a determination unit 240, a movement information acquisition unit 220, and a setting unit 230. An embodiment may be adopted where the server 60 does not have a part of the functions among the functional configuration illustrated in FIG. 3.

The index value acquisition unit 210 acquires the index value of the positioning precision based on the satellite signal detected by the terminal 82. For example, the index value acquisition unit 210 acquires the index value transmitted from the terminal 82.

The movement information acquisition unit 220 acquires the movement information of the terminal 82. For example, the movement information acquisition unit 220 acquires the movement information of the terminal 82 based on the location information of the terminal 82 transmitted from the terminal 82.

The storage unit 280 stores the map information. The storage unit 280 may store the map information received from the map server 54. The storage unit 280 may temporarily store the map information received from the map server 54.

The determination unit 240 determines whether or not the terminal 82 is indoors based on the comparison between the index value and the threshold. When the index value is equal to or less than the threshold, the determination unit 240 may determine that the terminal 82 is indoors. When the index value exceeds the threshold, the determination unit 240 may determine that the terminal 82 is not indoors.

The setting unit 230 sets the threshold based on the movement information and the map information. The map information may include the building information indicating the location of the building 92 and the setting unit 230 may set the threshold to a value higher than a predetermined value when it is determined that the terminal 82 is moving in the direction of approaching the building 92 based on the building information and the movement information.

The map information may include the building information indicating the location of the building 92 and the setting unit 230 may set the threshold to a value lower than a predetermined value when it is determined that the terminal 82 is moving in the direction of moving away from the building 92 based on the building information and the movement information.

The map information includes the building information indicating the location of the building 92, and the setting unit 230 may set the threshold to a higher value when it is determined that the terminal 82 is moving in the direction of approaching the building 92 based on the building information and the movement information than when it is determined that the terminal 82 is moving in the direction of moving away from the building 92.

The map information may include the obstacle information indicating the presence of the obstacle around the building 92. The obstacle information has been described above, and therefore, the description is omitted.

The setting unit 230 may set the threshold based on the obstacle information and the movement information. When it is determined that the terminal 82 is moving in the direction of approaching the obstacle based on the movement information and the obstacle information, the setting unit 230 may set the threshold to a value higher than a predetermined value. When it is determined that the terminal 82 is moving in the direction of moving away from the obstacle based on the obstacle information and the movement information, the setting unit 230 may set the threshold to a value lower than a predetermined value. When it is determined that the terminal 82 is moving in the direction of approaching the obstacle based on the obstacle information and the movement information, the setting unit 230 may set the threshold to a higher value than when it is determined that the terminal 82 is moving in the direction of moving away from the obstacle.

The communication control unit 270 performs control to transmit the information indicating the traffic risk at the location where the terminal 82 is located. When the determination unit 240 determines that the terminal 82 is indoors, the communication control unit 270 restricts the transmission of the information indicating the traffic risk at the location where the terminal 82 is located, relative to when the determination unit 240 determines that the terminal 82 is not indoors. In addition, the communication control unit 270 restricts the communication content between the server 60 and the terminal 82 when the terminal 82 is indoors based on the determination result of the determination unit 240. In this manner, the communication control unit 270 controls the communication content between the server 60 and the terminal 82 based on the determination result of the determination unit 240.

The assistance control unit 260 performs control related to assistance for traffic participants. The assistance control unit 260 distributes the information related to the traffic risk to the terminal 82 and the in-vehicle information processing device 40. For example, the assistance control unit 260 predicts the future locations of the vehicle 20 and the terminal 82 based on the location information of the vehicle 20 and the location information of the terminal 82, and predicts whether or not the vehicle 20 and the terminal 82 will approach each other within a predetermined distance within a predetermined time. When it is predicted that the vehicle 20 and the terminal 82 will approach each other within the predetermined distance within the predetermined time, the assistance control unit 260 transmits, to the terminal 82 and the vehicle 20, the warning information indicating to output a warning.

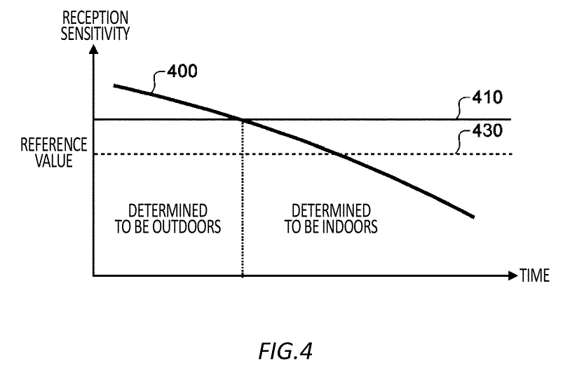

FIG. 4 schematically illustrates the temporal change of the satellite signal detected by the terminal 82 entering a building 92. The vertical axis of the graph in FIG. 4 indicates reception sensitivity of the satellite signal received by the terminal 82, and the horizontal axis indicates time. The reference value 430 indicated in FIG. 4 is a reference value (a predetermined value) of the threshold used to determine whether or not the terminal 82 is indoors. For example, in the terminal 82d, the reference value 430 is set as the threshold.

The reference mark 400 in FIG. 4 indicates the reception sensitivity of the satellite signal detected by the terminal 82 entering the building 92. As illustrated in FIG. 4, the reception sensitivity of the satellite signal detected by the terminal 82 entering the building 92 may decrease over time. When it is determined that the terminal 82 is moving in the direction of approaching the building 92 based on the movement information and the map information, the setting unit 330 changes the threshold to a first threshold 410.

The first threshold 410 is a value higher than the reference value 430. In this way, in the terminal 82 moving toward the building 92, the determination unit 340 can relatively quickly perform the determination that the terminal 82 is indoors. In this way, the transmission of the location information by the communication unit 390 can be stopped relatively quickly. Therefore, the consumption power amount in the terminal 82 can be reduced. Since the risk of traffic for the terminal 82 moving toward the building 92 is relatively low, the server 60 can appropriately determine the traffic risk even if the terminal 82 moving toward the building 92 stops transmitting the location information.

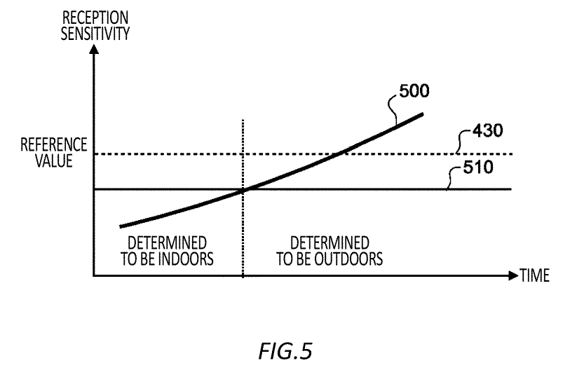

FIG. 5 schematically illustrates the temporal change of the satellite signal in the terminal 82 leaving the building 92. The vertical axis of the graph in FIG. 5 indicates the reception sensitivity of the satellite signal received by the terminal 82 and the horizontal axis indicates time. As in FIG. 4, the reference value 430 indicated in FIG. 5 is a reference value of the threshold used to determine whether or not the terminal 82 is indoors.

The reference mark 500 in FIG. 5 indicates the reception sensitivity of the satellite signal detected by the terminal 82 leaving the building 92. As illustrated in FIG. 5, the reception sensitivity of the satellite signal detected by the terminal 82 leaving the building 92 may increase over time. When it is determined that the terminal 82 is moving in the direction of leaving the building 92 based on the movement information and the map information, the setting unit 330 changes the threshold to the second threshold 510.

The second threshold 510 is lower than the reference value 430. The second threshold 510 is lower than the first threshold 410. In this way, in the terminal 82 moving in the direction of leaving the building 92, the determination unit 340 can relatively quickly perform the determination that the terminal 82 is not indoors (for example, in the present embodiment, the determination that it is outdoors). In this way, the transmission of the location information by the communication unit 390 can be started relatively quickly. Therefore, it is possible to prevent the server 60 from delaying the start of the process for determining the traffic risk in the terminal 82.

The process for setting the threshold by the setting unit 330 of the terminal 82 has been described with reference to FIG. 4 and FIG. 5. The process similar to the process for setting the threshold by the setting unit 330 of the terminal 82 can also be applied to the process for setting the threshold by the setting unit 230 of the server 60, and therefore the description for the latter will be omitted.

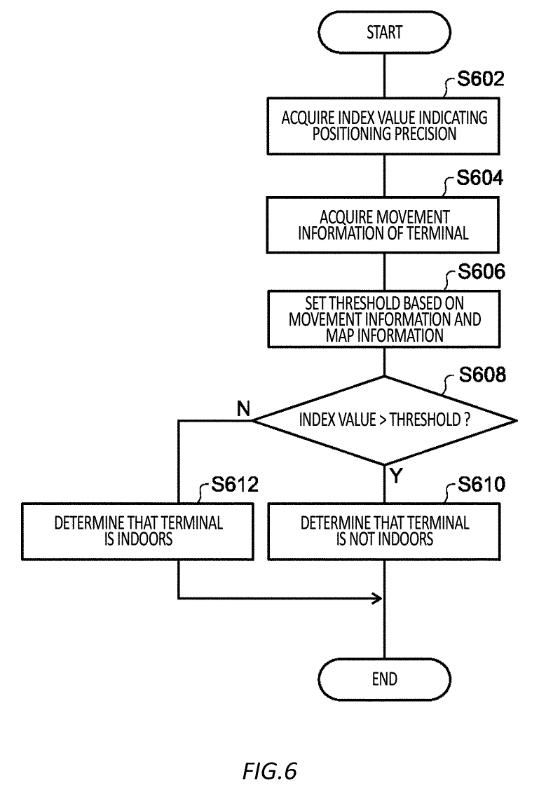

FIG. 6 illustrates a flowchart related to a determination method executed in the terminal 82 and the server 60. FIG. 6 describes the determination method for determining, by the terminal 82 itself, whether or not the terminal 82 is indoors. The process of this flowchart is periodically executed in the terminal 82. For example, the process of this flowchart is started when the terminal 82 performs positioning.

In S602, the index value acquisition unit 310 acquires the index value indicating the positioning precision of the terminal 82. Specifically, the index value acquisition unit 310 acquires the index value output from the satellite signal reception unit 304.

In S604, the movement information acquisition unit 320 acquires the movement information of the terminal 82. The movement information acquisition unit 320 may acquire the movement information based on the history of the location of the terminal 82 positioned by the satellite signal reception unit 304. The movement information may be the information indicating the current location of the terminal 82 and the moving direction of the terminal 82.

In S606, the setting unit 330 sets the threshold used to determine whether or not the terminal 82 is indoors. As described with reference to FIG. 4, FIG. 5, and the like, the setting unit 330 determines, based on the movement information and the map information, whether the terminal 82 is moving in the direction of approaching the building 92 or whether or not the terminal 82 is moving in the direction of moving away from the building 92, and sets the threshold based on the determination result. The setting unit 330 may set the threshold based on the movement information, and the building information and/or the obstacle information included in the map information.

The setting unit 330 may determine that the terminal 82 is moving in the direction of approaching the building 92 when the building 92 is located ahead in the moving direction of the terminal 82 based on the map information and the current location of the terminal 82 and the moving direction of the terminal 82. The setting unit 330 determines that the terminal 82 is moving in the direction of approaching the building 92 when the current location of the terminal 82 is determined to be outside the building 92, and the building 92 is determined to be located ahead in the moving direction of the terminal 82, and the distance between the current location of the terminal 82 and the location of the building 92 is determined to be shorter than a predetermined distance based on the map information and the current location of the terminal 82 and the moving direction of the terminal 82.

The setting unit 330 may determine that the terminal 82 is moving in the direction of moving away from the building 92 when it is determined, based on the map information and the current location of the terminal 82 and the moving direction of the terminal 82, that the distance between the terminal 82 and the location of the building 92 is shorter than a predetermined distance and that the matching rate of the direction between the moving direction of the terminal 82 and the direction of moving away from the building 92 is higher than a predetermined value. The setting unit 330 may determine that the terminal 82 is moving in the direction of moving away from the building 92, regardless of whether or not the current location of the terminal 82 is determined to be within the building 92.

In S608, the determination unit 340 determines whether or not the index value acquired in S602 exceeds the threshold set in the S608. In S608, the determination unit 340 determines that the terminal 82 is not indoors when it determines that the index value exceeds the threshold. Specifically, the determination unit 340 determines that the terminal 82 is outdoors.

In S608, the determination unit 340 determines that the terminal 82 is indoors when it determines that the index value does not exceed the threshold.

In the example in FIG. 6, the process in the case where the terminal 82 itself determines whether or not the terminal 82 is indoors has been described. When the server 60 determines whether or not the terminal 82 is indoors, the server 60 periodically receives the location information and the index value from the terminal 82 and determines whether or not the terminal 82 is indoors based on the received information. Specifically, in the server 60, the index value acquisition unit 210, the determination unit 240, the movement information acquisition unit 220, and the setting unit 230 perform the processes corresponding to the index value acquisition unit 310, the determination unit 340, the movement information acquisition unit 320, and the setting unit 330 of the terminal 82, respectively. More specifically, in S602, the index value acquisition unit 210 acquires the index value transmitted from the terminal 82 and, in S604, the movement information acquisition unit 220 may acquire the movement information of the terminal 82 based on the history of the location information of the terminal 82. In S606, S608, S610, and S612, the processes of the setting unit 330 and the determination unit 340 are similar to the processes of the setting unit 230 and the determination unit 240, respectively.

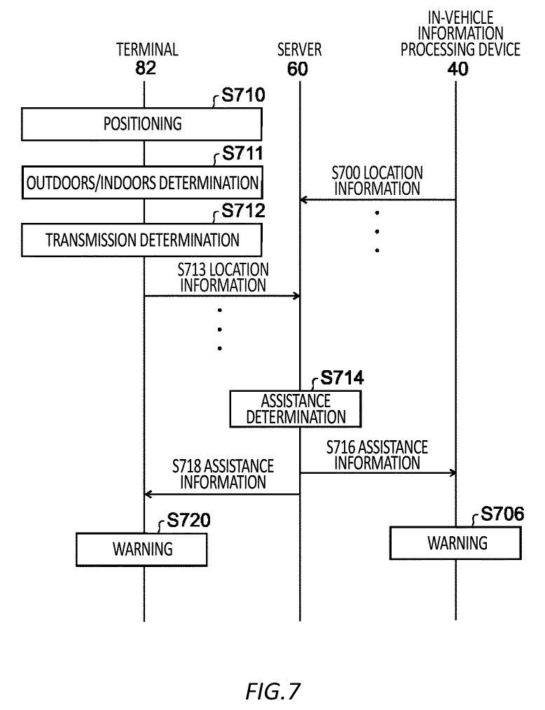

FIG. 7 illustrates an example of an execution sequence of processes performed at the terminal 82, the in-vehicle information processing device 40 of the vehicle 20, and the server 60. FIG. 7 particularly illustrates the execution sequence in a case where the terminal 82 itself determines whether or not the terminal 82 is indoors and the terminal 82 determines whether or not to transmit the location information.

In S710, the satellite signal reception unit 304 of the terminal 82 performs the positioning based on the satellite signal received from the GNSS satellite and outputs the current location of the terminal 82. In this case, the satellite signal reception unit 304 further outputs the index value indicating the positioning precision. The index value may be the information indicating, for example, the reception sensitivity of the satellite signal, the number of received satellites, the accuracy value, the elevation angle of the satellite signal, and the like. The index value acquisition unit 310 of the terminal 82 acquires the index value output by the satellite signal reception unit 304.

In S711, the terminal 82 determines whether or not the terminal 82 is indoors. Specifically, the setting unit 330 determines whether or not the terminal 82 is moving in the direction of approaching the building 92 based on the movement information of the terminal 82 acquired by the movement information acquisition unit 320 and the map information stored in the storage unit 380, and sets the threshold based on the determination result. The determination unit 340 determines whether or not the terminal 82 is indoors by comparing the index value and the threshold.

In S712, the communication control unit 370 of the terminal 82 determines whether or not to transmit the location information. When the determination unit 340 determines that the terminal 82 is not indoors, the communication control unit 370 decides to transmit the location information. On the other hand, when the determination unit 340 determines that the terminal 82 is indoors, the communication control unit 370 decides not to transmit the location information. In this execution sequence, a case where the communication control unit 370 decides to transmit the location information will be described.

In S713, the communication control unit 370 transmits, to the server 60, the location information indicating the current location of the terminal 82 measured by the satellite signal reception unit 304. The processes from S710 to S713 are periodically executed at the terminal 82.

In S700, the in-vehicle information processing device 40 transmits the location information of the vehicle 20 to the server 60. The transmission of the location information from the in-vehicle information processing device 40 to the server 60 is periodically performed.

In S714, the assistance control unit 260 of the server 60 determines whether or not to perform the traffic assistance for the vehicle 20 and the terminal 82 based on the location information of the terminal 82 acquired from the terminal 82 and the location information of the vehicle 20 acquired from the in-vehicle information processing device 40.

For example, the assistance control unit 260 predicts the future location of the terminal 82 based on the history of the location information of the terminal 82 and also predicts the future location of the vehicle 20 based on the history of the location information of the vehicle 20. The assistance control unit 260 determines to perform traffic assistance when it is predicted that the future location of the vehicle 20 will approach the future location of the terminal 82 within a predetermined time based on the predicted future locations of the terminal 82 and the vehicle 20.

When it is determined to perform traffic assistance, in S716, the assistance control unit 260 controls the communication unit 290 through the communication control unit 270 to transmit, to the in-vehicle information processing device 40, the assistance information indicating to output a warning. Furthermore, in S718, the assistance control unit 260 controls the communication unit 290 through the communication control unit 270 to transmit, to the terminal 82, the assistance information indicating to output a warning. In this manner, the communication control unit 270 performs control to transmit the information indicating the traffic risk at the location where the terminal 82 is located under the control of the assistance control unit 260.

Once the in-vehicle information processing device 40 receives the assistance information from the server 60, in S706, it performs notification to the passenger of the vehicle 20 according to the assistance information through the Human Machine Interface (HMI) function of the in-vehicle information processing device 40. For example, the in-vehicle information processing device 40 notifies the passenger to be cautious of a pedestrian suddenly entering the road 90. The in-vehicle information processing device 40 may notify the passenger in the vehicle 20 to be cautious of a pedestrian suddenly entering the road 90 through voice and display on a display device provided in the vehicle 20.

Once receiving the assistance information from the server 60, in S720, the terminal 82 notifies, through the HMI function of the terminal 82, the person 80 that there is a vehicle 20 approaching the person 80. The terminal 82 may notify the person 80, through voice and/or vibration, that there is a vehicle approaching the person 80.

According to the execution sequence in FIG. 7, while the terminal 82 is determined to be indoors, the transmission of the location information can be suppressed. Therefore, the consumption power amount at the terminal 82 can be reduced. In addition, since the processing of the location information of the terminal 82 located indoors by the server 60 can be suppressed, the computation amount required for the process executed by the server 60 can be reduced. Furthermore, when it is determined that the terminal 82 is indoors, the output of the warning information can be suppressed. Therefore, the output of the warning from the terminal 82 located indoors can be suppressed. In this way, inconvenience due to undesired warning being output from the terminal 82 can be mitigated.

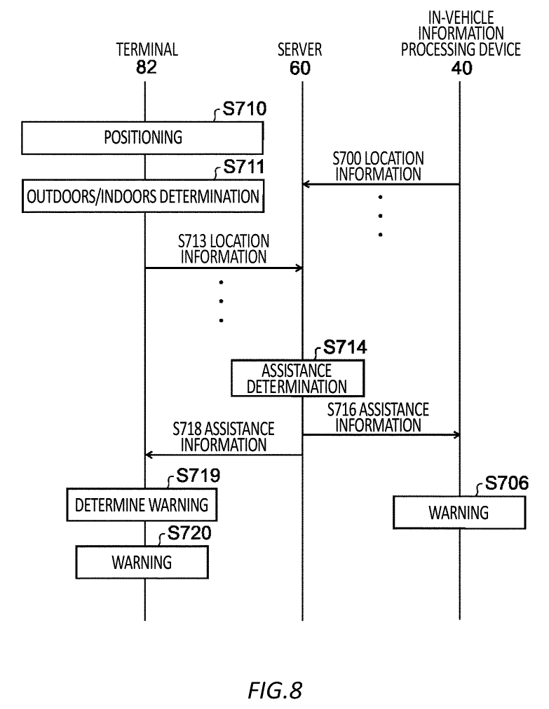

FIG. 8 illustrates another example of an execution sequence of processes performed at the terminal 82, the in-vehicle information processing device 40 of the vehicle 20, and the server 60. In particular, FIG. 8 illustrates the execution sequence in the case where the terminal 82 itself determines whether or not the terminal 82 is indoors and determines, based on the determination result, whether or not the terminal 82 outputs a warning.

For the processes of S700, S706, S710, S711, S713, S714, S716, and S718 in FIG. 7 and FIG. 8, the processes with the same reference mark represent the same process, and therefore, the description of those processes is omitted.

In S718, the assistance information indicating to output a warning is transmitted to the terminal 82 under the control of the assistance control unit 260. Once the terminal 82 receives the assistance information from the server 60, in S719, it determines whether or not to output the warning. Specifically, when the terminal 82 is determined to be indoors in the most recent determination of indoors or outdoors by the determination unit 340, the notification control unit 360 of the terminal 82 decides to output the warning. When the terminal 82 is determined not to be indoors in the most recent determination of indoors or outdoors by the determination unit 340, the notification control unit 360 decides not to output the warning. In this execution sequence, the case where the notification control unit 360 decides to output the warning is described.

When the notification control unit 360 decides to output the warning in S719, it uses the HMI function of the terminal 82 to notify the person 80 that there is a vehicle 20 approaching the person 80 in S720. Because the process of S720 in FIG. 8 is the same as the process of S720 in FIG. 7, the description of the process is omitted.

According to the execution sequence in FIG. 8, when it is determined that the terminal 82 is indoors, the output of the warning information can be suppressed. Therefore, the output of the warning from the terminal 82 located indoors can be suppressed. In this way, inconvenience due to undesired warning being output from the terminal 82 can be mitigated.

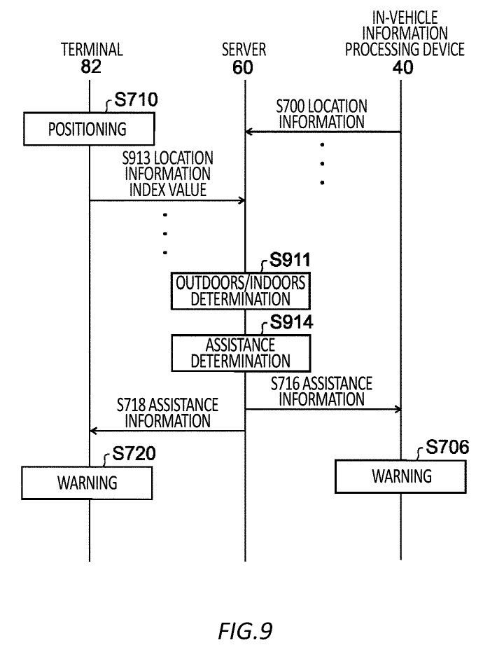

FIG. 9 illustrates another example of an execution sequence of processes performed at the terminal 82, the in-vehicle information processing device 40 of the vehicle 20, and the server 60. FIG. 9 particularly illustrates the execution sequence in the case where the server 60 determines whether or not the terminal 82 is indoors.

For the processes of S700, S706, S710, S716, S718, and S720 in FIG. 9 and FIG. 7, the processes with the same reference mark represent the same process and therefore the description of those processes is omitted.

In S913, the communication control unit 370 transmits, to the server 60, the location information indicating the current location of the terminal 82 measured by the satellite signal reception unit 304 and the index value indicating the positioning precision output from the satellite signal reception unit 304 in S710. The processes of S710 and S913 are periodically executed in the terminal 82.

In S911, the server 60 determines whether or not the terminal 82 is indoors. Specifically, the movement information acquisition unit 220 acquires the movement information of the terminal 82 based on the location information transmitted from the terminal 82. The setting unit 230 determines whether or not the terminal 82 is moving in the direction of approaching the building 92 based on the movement information of the terminal 82 acquired by the movement information acquisition unit 220 and the map information stored in the storage unit 280, and sets the threshold based on the determination result. The determination unit 240 determines whether or not the terminal 82 is indoors by comparing the index value and the threshold.

In S914, the assistance control unit 260 of the server 60 determines whether or not to perform the traffic assistance for the vehicle 20 and the terminal 82 based on the location information of the terminal 82 acquired from the terminal 82 and the location information of the vehicle 20 acquired from the in-vehicle information processing device 40. In this case, the assistance control unit 260 determines, for the terminal 82 determined not to be indoors by the determination unit 240, whether or not to perform traffic assistance for the vehicle 20 and the terminal 82, excluding the terminal 82 determined to be indoors by the determination unit 240. Except for this, the process of the assistance control unit 260 in S914 is the same as the process described with reference to S714 in FIG. 7.

According to the execution sequence in FIG. 9, since the determination of assistance in S914 for the terminal 82 located indoors can be suppressed, the computation amount for the process executed by the server 60 can be reduced. In addition, since the output of the warning information can be suppressed in the terminal 82 determined to be indoors, the inconvenience due to undesired warning being output from the terminal 82 can be mitigated.

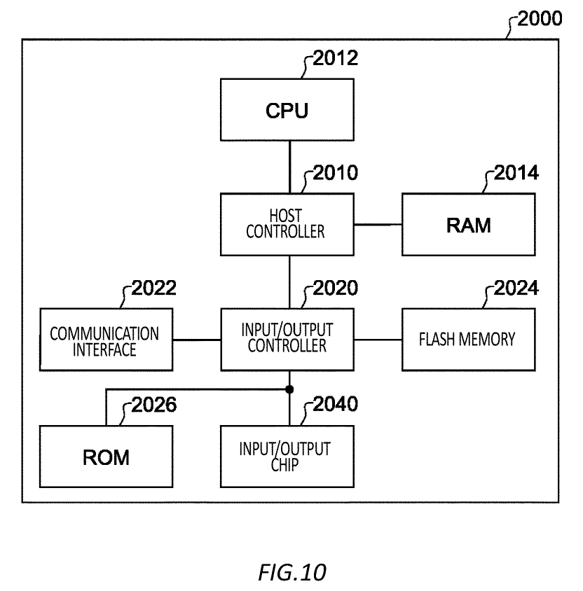

FIG. 10 illustrates an example of a computer 2000 in which a plurality of embodiments of the present invention may be entirely or partially embodied. The program installed on the computer 2000 can cause the computer 2000 to function as a device such as the terminal 82 and the server 60 according to the embodiments or each part of the device, execute the operations associated with the device or each part of the device, and/or execute a process according to the embodiments or a step of the process. Such a program may be executed by a CPU 2012 in order to cause the computer 2000 to execute a specific operation associated with some or all of the processing procedures and the blocks in the block diagrams described in the present specification.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates in accordance with programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 during activation and/or a program depending on the hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, an HDMI (registered trademark) port.

A program is provided via a network or a computer-readable storage medium such as a CD-ROM, a DVD-ROM, or a memory card. The RAM 2014, the ROM 2026, or the flash memory 2024 is an example of the computer-readable storage medium. The program is installed in the flash memory 2024, the RAM 2014, or the ROM 2026, and executed by the CPU 2012. The information processing described within these programs is read by the computer 2000, resulting in the cooperation between the program and the above-described various types of hardware resources. A device or a method may be constructed by realizing operations or processing of information in accordance with a use of the computer 2000.

For example, when a communication is executed between the computer 2000 and an external device, the CPU 2012 may execute a communication program loaded on the RAM 2014, and instruct the communication interface 2022 to execute communication processing based on processing described in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 and the like to be read into the RAM 2014, and execute various types of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various types of processing including various types of operations, information processing, conditional judgement, conditional branching, unconditional branching, information search/replacement, or the like described in the present specification and designated by instruction sequences of the programs, and write back a result into the RAM 2014. In addition, the CPU 2012 may search for information in a file, a database, or the like in the recording medium. For example, when a plurality of entries each having an attribute value of a first attribute associated with an attribute value of a second attribute, is stored in the recording medium, the CPU 2012 may search for an entry having a designated attribute value of the first attribute that matches a condition from said plurality of entries, and read the attribute value of the second attribute stored in said entry, thereby obtaining the attribute value of the second attribute associated with the first attribute that satisfies a predetermined condition.

The program or software module described above may be stored in a computer-readable storage medium on the computer 2000 or near the computer 2000. A recording medium such as a hard disk or a RAM provided in a server system connected to a dedicated communication network or the Internet can be used as the computer-readable storage medium. A program stored in the computer-readable storage medium may be provided to the computer 2000 via a network.

The program that is installed on the computer 2000 and causes the computer 2000 to function as the terminal 82 may instruct the CPU 2012 or the like to cause the computer 2000 to respectively function as each part of the terminal 82 (for example, the determination device 302 or the like). The information processing described by these programs is read by the computer 2000, and thus the software and the various hardware resources described above function as each part of the terminal 82, which is a specific means in which they cooperate. Then, with these specific means, by achieving computing or processing of information according to an intended use of the computer 2000 in the present embodiment, the specific terminal 82 is constructed according to the intended use.

The program that is installed on the computer 2000 and causes the computer 2000 to function as the server 60 may instruct the CPU 2012 or the like to cause the computer 2000 to respectively function as each part of the server 60 (for example, the determination device 202 or the like). The information processing described in these programs is read by the computer 2000 and thus the software and the various hardware resources described above function as each part of the server 60, which is a specific means in which they cooperate. Then, with these specific means, by realizing the computing or processing of information according to an intended use of the computer 2000 in the present embodiment, the specific server 60 is constructed according to the intended use.

Various embodiments have been described with reference to the block diagrams and the like. In the block diagrams, each block may represent (1) a step of a process in which an operation is executed, or (2) each part of the device having a role in executing the operation. A particular step and each part may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including a logical AND, a logical OR, a logical XOR, a logical NAND, a logical NOR, and another logical operation, a memory element such as a flip flop, a register, a field programmable gate array (FPGA), or a programmable logic array (PLA), and the like.

The computer-readable storage medium may include any tangible device capable of storing instructions to be executed by an appropriate device, so that the computer-readable storage medium having instructions stored therein constitutes at least a part of a product including instructions which can be executed to provide means for executing processing procedures or operations designated in the block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a FLOPPY (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disk (DVD), a BLU-RAY (registered trademark) disk, a memory stick, an integrated circuit card, or the like.

The computer-readable instruction may include any of a source code or an object code described in any combination of one or more programming languages including an assembler instruction, an instruction set architecture (ISA) instruction, a machine instruction, a machine dependent instruction, a microcode, a firmware instruction, state setting data, or an object-oriented programming language such as Smalltalk (registered trademark), JAVA (registered trademark), C++, and the like, and a conventional procedural programming language such as a “C” programming language or a similar programming language.

Computer-readable instructions may be provided to a processor of a general purpose computer, a special purpose computer, or another programmable data processing device, or to programmable circuit, locally or via a local area network (LAN), wide area network (WAN) such as the Internet or the like, and a computer-readable instruction may be executed to provide means for executing operations designated in the described processing procedures or block diagrams. Examples of the processor include a computer processor, a processing unit, a microprocessor, a digital signal processor, a controller, a microcontroller, and the like.

While the present invention has been described above by way of the embodiments, the technical scope of the present invention is not limited to the scope described in the above-described embodiments. It is apparent to persons skilled in the art that various alterations or improvements can be made to the above-described embodiments. It is also apparent from the description of the claims that the form to which such alterations or improvements are made can be included in the technical scope of the present invention.

The operations, procedures, steps, and stages etc. of each process performed by a device, system, program, and method shown in the claims, specification, or diagrams can be executed in any order as long as the order is not indicated by "before", "prior to", or the like and as long as the output from a previous process is not used in a later process. Even if the operation flow is described by using phrases such as "first" or "next" for the sake of convenience in the claims, specification, and drawings, it does not necessarily mean that the process must be performed in this order.

### EXPLANATION OF REFERENCES

10 assistance system;

20 vehicle;

40 in-vehicle information processing device;

54 map server;

60 server;

82 terminal;

92 building;

80 person;

90 road;

200 processing unit;

202 determination device;

210 index value acquisition unit;

220 movement information acquisition unit;

230 setting unit;

240 determination unit;

260 assistance control unit;

270 communication control unit;

280 storage unit;

290 communication unit;

300 processing unit;

302 determination device;

304 satellite signal reception unit;

310 index value acquisition unit;

320 movement information acquisition unit;

330 setting unit;

340 determination unit;

360 notification control unit;

370 communication control unit;

380 storage unit;

390 communication unit;

410 first threshold;

510 second threshold;

2000: computer;

2010: host controller;

2012 CPU;

2014 RAM;

2020 input/output controller;

2022 communication interface;

2024: flash memory;

2026 ROM;

2040 input/output chip.

What is claimed is:

1. A determination device comprising:
an index value acquisition unit which acquires an index value of a positioning precision based on a satellite signal detected by a terminal;
a movement information acquisition unit which acquires movement information of the terminal;
a storage unit which stores map information;
a determination unit which determines, based on a comparison between the index value and a threshold, whether or not the terminal is indoors; and
a setting unit which sets the threshold based on the movement information and the map information.

2. The determination device according to claim 1, wherein the map information includes building information indicating a location of a building, and
when it is determined, based on the building information and the movement information, that the terminal is moving in a direction of approaching the building, the setting unit sets the threshold to a value higher than a predetermined value.

3. The determination device according to claim 1, wherein the map information includes building information indicating a location of a building, and
when it is determined, based on the building information and the movement information, that the terminal is moving in a direction of moving away from the building, the setting unit sets the threshold to a value lower than a predetermined value.

4. The determination device according to claim 1, wherein the map information includes building information indicating a location of a building, and
when it is determined, based on the building information and the movement information, that the terminal is moving in a direction of approaching the building, the setting unit sets the threshold to a higher value than when it is determined that the terminal is moving in a direction of moving away from the building.

5. The determination device according to claim 1, wherein the map information includes obstacle information indicating a location of an obstacle around a building, and
the setting unit sets the threshold based on the obstacle information.

6. The determination device according to claim 1, wherein the index value indicates at least one of a reception sensitivity of the satellite signal, a number of satellites used for positioning, or an elevation angle of the satellite signal.

7. The determination device according to claim 2, wherein, when it is determined, based on the building information and the movement information, that the terminal is moving in a direction of moving away from the building, the setting unit sets the threshold to a value lower than a predetermined value.

8. The determination device according to claim 2, wherein the map information includes obstacle information indicating a location of an obstacle around a building, and
the setting unit sets the threshold based on the obstacle information.

9. The determination device according to claim 3, wherein the map information includes obstacle information indicating a location of an obstacle around a building, and
the setting unit sets the threshold based on the obstacle information.

10. The determination device according to claim 2, wherein the index value indicates at least one of a reception sensitivity of the satellite signal, a number of satellites used for positioning, or an elevation angle of the satellite signal.

11. The determination device according to claim 1, wherein the index value indicates at least a number of satellites used for positioning.

12. A terminal comprising:
the determination device according to claim 1; and
a satellite signal reception unit which receives the satellite signal.

13. The terminal according to claim 12, further comprising:
a communication control unit which controls communication content between the terminal and an external server based on determination result of the determination unit.

14. The terminal according to claim 12, further comprising:
a communication unit which transmits location information of the terminal to a server which distributes information indicating traffic risk at a location where the terminal is located; and
a communication control unit which restricts transmission of the location information by the communication unit to the server based on determination result of the determination unit.

15. The terminal according to claim 12, comprising:
a communication unit which receives, from a server which distributes information indicating traffic risk, information indicating traffic risk at a location where the terminal is located; and
a notification control unit which performs control to perform notification based on information indicating the traffic risk received by the communication unit,
wherein, when it is determined that the terminal is indoors by the determination unit, the notification control unit restricts the notification.

16. A server comprising:
the determination device according to claim 1.

17. The server according to claim 16, further comprising:
a communication control unit which controls communication content between the server and the terminal based on determination result of the determination unit.

18. The server according to claim 16, further comprising:
a communication control unit which performs control to transmit information indicating traffic risk at a location where the terminal is located,
wherein, when the determination unit determines that the terminal is indoors, the communication control unit restricts transmission of information indicating traffic risk at a location where the terminal is located, relative to when the determination unit determines that the terminal is not indoors.

19. A determination method comprising:
acquiring an index value of a positioning precision based on a satellite signal detected by a terminal;
acquiring movement information of the terminal;
storing map information;
setting a threshold based on the movement information and the map information; and
determining whether or not the terminal is indoors based on a comparison between the index value and the threshold.

20. A non-transitory computer-readable storage medium having a program stored therein, the program, when executed by a computer, causing the computer to function as:
an index value acquisition unit which acquires an index value of a positioning precision based on a satellite signal detected by a terminal;
a movement information acquisition unit which acquires movement information of the terminal;
a storage unit which stores map information;
a determination unit which determines whether or not the terminal is indoors based on a comparison between the index value and a threshold; and
a setting unit which sets the threshold based on the movement information and the map information.
